(19) United States
(12) Patent Application Publication
(10) Pub. No.: US 2014/0208385 A1
(43) Pub. Date: Jul. 24, 2014

(54) METHOD, APPARATUS AND SYSTEM FOR WEBPAGE ACCESS CONTROL

(71) Applicant: TENCENT TECHNOLOGY (SHENZHEN) COMPANY LIMITED, Shenzhen (CN)

(72) Inventors: GAOQIAN XU, Shenzhen (CN); DONG WANG, Shenzhen (CN); YANGYING QIU, Shenzhen (CN)

(73) Assignee: TENCENT TECHNOLOGY (SHENZHEN) COMPANY LIMITED, Shenzhen (CN)

(21) Appl. No.: 14/211,523

(22) Filed: Mar. 14, 2014

Related U.S. Application Data
(63) Continuation of application No. PCT/CN2013/087214, filed on Nov. 15, 2013.

(30) Foreign Application Priority Data
Jan. 24, 2013 (CN) 201310027235.5

(51) Int. Cl. H04L 29/06

(52) U.S. Cl. CPC H04L 63/10
USPC 726/3

(57) ABSTRACT

A method is provided for webpage access control. The method includes sending a webpage access request which carries a first URL to a browser control and receiving N number of callbacks corresponding to the webpage access request. The method also includes comparing a second URL carried in a first callback with recorded M number of trusted URLs. Further, the method includes instructing the browser control to access a webpage corresponding to the second URL when the second URL is the same as one of the M trusted URLs. When the second URL is different from any one of the M trusted URLs, the method includes instructing the browser control to cancel the webpage access request when the webpage is not an embedded sub-webpage and instructing the browser control to deny display of the sub-webpage but to allow display an original webpage when the webpage is an embedded sub-webpage.

### CROSS-REFERENCES TO RELATED APPLICATIONS

This application is a continuation application of PCT Patent Application No. PCT/CN2013/087214, filed on Nov. 15, 2013, which claims priority of Chinese Patent

Application No. 201310027235.5, filed on Jan. 24, 2013, the entire contents of all of which are incorporated by reference herein.

### FIELD OF THE INVENTION

The present invention generally relates to network security technologies and, more particularly, to a method, apparatus and system for webpage access control.

### BACKGROUND

With the development of Internet technologies, the number and type of computer viruses have increased dramatically. Currently, some viruses often hide in the infected hosts and mislead users to access harmful websites (e.g., phishing websites, pornographic websites, etc.) through tampering with Uniform/Universal Resource Locators (URLs) of webpage access requests which are initiated by clients, greatly affecting the security of Internet resources.

For existing technologies, after a client sends a webpage access request, the client may receive multiple callbacks corresponding to the webpage access request from a WebBrowser control. If the client finds that a URL carried in any callback is suspicious, the client may directly cancel the requested webpage access and display.

These existing technologies may have certain limitations. For example, such defense mechanisms of existing technologies often greatly affect users' normal webpage browsing, and the flexibility of such existing defense mechanisms is poor.

The disclosed method, apparatus and system are directed to solve one or more problems set forth above and other problems.

### BRIEF SUMMARY OF THE DISCLOSURE

One aspect of the present disclosure includes a method for webpage access control. The method includes sending a webpage access request which carries a first URL to a browser control and receiving N number of callbacks corresponding to the webpage access request from the browser control, where N is an integer greater than 1. The method also includes comparing a second URL carried in a first callback with recorded M number of trusted URLs, where M is a positive integer and the first callback is any one callback among the N callbacks. Further, the method includes instructing the browser control to access a webpage corresponding to the second URL when the second URL is the same as one of the M trusted URLs and determining whether the webpage is an embedded sub-webpage when the second URL is different from any one of the M trusted URLs. The method includes instructing the browser control to cancel the webpage access request when it is determined that the webpage is not an embedded sub-webpage and instructing the browser control to deny display of the sub-webpage but to allow display an original webpage when it is determined that the webpage is an embedded sub-webpage.

Another aspect of the present disclosure includes an apparatus for webpage access control. The apparatus includes a sending unit configured to send a webpage access request which carries a first URL to a browser control and a receiving unit configured to receive N number of callbacks corresponding to the webpage access request from the browser control, where N is an integer greater than 1. The apparatus also includes a comparing unit configured to compare a second URL carried in a first callback with recorded M number of trusted URLs, where M is a positive integer and the first callback is any one callback among N number of callbacks. Further, the apparatus includes a control unit configured to instruct the browser control to access a webpage corresponding to the second URL when the second URL is the same as one of the M trusted URLs, to determine whether the webpage is an embedded sub-webpage when the second URL is different from any one of the M trusted URLs, to instruct the browser control to deny access to or deny display of the webpage corresponding to the second URL when it is determined that the webpage is not an embedded sub-webpage, and to instruct the browser control to deny display of the sub-webpage but to allow display an original webpage when it is determined that the webpage is an embedded sub-webpage.

Another aspect of the present disclosure includes a system for webpage access control. The system includes a webpage server configured to provide webpages. The system also includes a DNS server configured to manage a database that maps domain names to IP addresses. Further, the system includes a browser control configured to receive a webpage access request which carries a first URL from a client and to return N number of callbacks corresponding to the webpage access request to the client, where the first callback is any one callback among N number of callbacks. The system includes the client configured to send the webpage access request which carries the first URL to the browser control, to receive N number of callbacks corresponding to the webpage access request from the browser control, to compare a second URL carried in a first callback with recorded M number of trusted URLs, to instruct the browser control to access a webpage corresponding to the second URL when the second URL is the same as one of the M trusted URLs, to determine whether the webpage is an embedded sub-webpage when the second URL is different from any one of the M trusted URLs, to instruct the browser control to deny access to or deny display of the webpage corresponding to the second URL when it is determined that the webpage is not an embedded sub-webpage, and to instruct the browser control to deny display of the sub-webpage but to allow display an original webpage when it is determined that the webpage is an embedded sub-webpage.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions of the present invention, the figures which are needed to be used in the description of the present invention or the existing technology are briefly described in the following. Obviously, the figures in the following description are only some embodiments of the present invention, and it is easily for those skilled in the art to obtain other figures based on the following figures without creative work.

FIG. 1 illustrates a flow chart of an exemplary webpage access control process consistent with the disclosed embodiments;

FIG. 2 illustrates a flow chart of another exemplary webpage access control process consistent with the disclosed embodiments;

FIG. 3 illustrates a flow chart of another exemplary webpage access control process consistent with the disclosed embodiments;

FIG. 4 illustrates a structure diagram of an exemplary webpage access control apparatus consistent with the disclosed embodiments;

FIG. 5 illustrates a structure diagram of an exemplary webpage access control system consistent with the disclosed embodiments;

FIG. 6 illustrates a block diagram of an exemplary user terminal consistent with the disclosed embodiments; and

FIG. 7 illustrates a block diagram of an exemplary communication system consistent with the disclosed embodiments; and

FIG. 8 illustrates a flow chart of another exemplary webpage access control process consistent with the disclosed embodiments.

### DETAILED DESCRIPTION

To make the objectives and technical solutions of the present disclosure more comprehensible, the following describes the technical solutions according to the embodiments of the present disclosure with reference to the accompanying drawings. Apparently, the embodiments in the following description are merely examples. All other embodiments obtained by persons of ordinary skill in the art based on the embodiments of the present disclosure without creative efforts shall fall within the protection scope of the present disclosure.

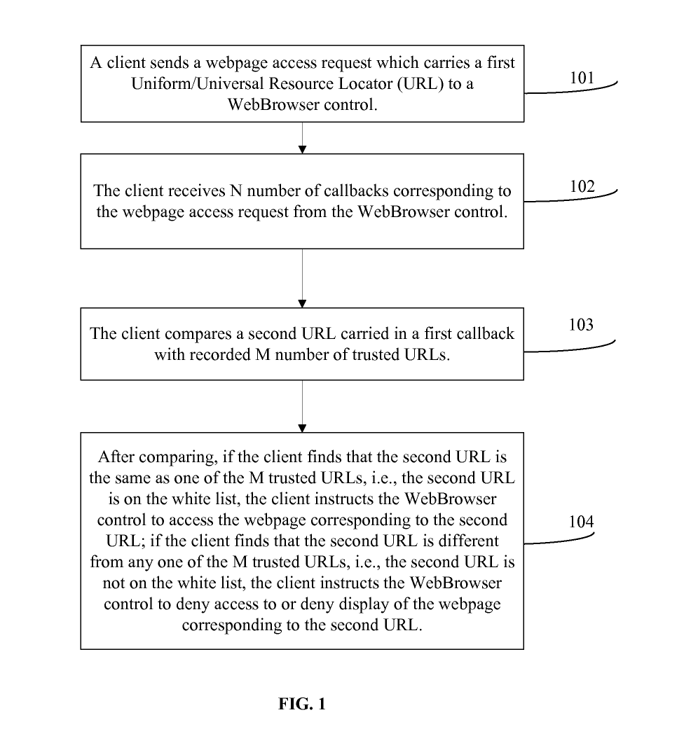

FIG. 1 illustrates a flow chart of an exemplary webpage access control process consistent with the disclosed embodiments. As shown in FIG. 1, the webpage access control process may include the following steps.

Step 101: a client sends a webpage access request which carries a first

Uniform/Universal Resource Locator (URL) to a WebBrowser control.

As used herein, a client may refer to any user terminal and/or any software program running on the user terminal, and the client may communicate with a WebBrowser control, e.g., a QQ client, a QQ game client, a QQ microblog client, other instant messaging clients, other social software clients, etc. WebBrowser control may also be seen written as browser control.

When the client sends the webpage access request which carries the first URL to the WebBrowser control, the first URL carried in the webpage access request may be tampered with during the process of transferring the webpage access request. For example, a virus program may modify the first URL carried in the webpage access request, making the modified URL point to a phishing website, a pornographic website, a virus infected website, etc.

Step 102: the client receives N number of callbacks corresponding to the webpage access request from the WebBrowser control. N is a positive integer. For example, N may be 1, 2, or any integer greater than 1.

Each callback corresponding to the webpage access request returned from the WebBrowser control may carry a URL. The URL carried in any callback may be the same as the first URL, or may be different from the first URL.

Step 103: the client compares a second URL carried in a first callback with recorded M number of trusted URLs. The first callback may be any one callback among N callbacks.

In certain embodiments, a white list can be used to record M number of trusted URLs. White list may also be seen written as whitelist or white-list. The white list refers to a list that includes all real websites' domain name address being provided a particular privilege, service, mobility, access or recognition. Only those websites on the white list are accepted, approved or recognized. Of course, the M trusted URLs recorded on the white list may include the first URL, where M is a positive integer. Further, the client compares the second URL carried in the first callback with the M trusted URLs recorded on the white list.

Step 104: after comparing, if the client finds that the second URL is the same as one of the M trusted URLs, i.e., the second URL is on the white list, the client instructs the WebBrowser control to access the webpage corresponding to the second URL; if the client finds that the second URL is different from any one of the M trusted URLs, i.e., the second URL is not on the white list, the client instructs the WebBrowser control to deny access to or deny display of the webpage corresponding to the second URL.

Before the WebBrowser control jumps to a webpage, the WebBrowser control sends a notification which includes relevant data of the webpage to be jumped (e.g., a URL of the webpage, a pointer for displaying the webpage frame, etc.) to the client by the callback method, so that the client can determine whether or not to visit the webpage.

In practice, under an actual webpage access scenario, when the client sends the webpage access request to the WebBrowser control, there are possible many jumps (webpage jumps, sub-webpage jumps, etc.). For each jump, the client can receive a callback returned from the WebBrowser control. Each time the WebBrowser control returns the URL of the webpage to be jumped to the client through the callback. If any time the URL carried in the callback which is returned from the WebBrowser control to the client is not on the white list, the entire request process may be canceled and a risk warning webpage is directly displayed, but this may greatly affect normal functions. Further, in general, malicious tampering with webpage access may include directly tampering with URL and tampering with webpage content by embedding sub-webpages.

For example, floating ads, phishing scams and other illegal webpages are displayed by adding JavaScript (JS) codes in the webpage. In this case, based on defense mechanisms consistent with the disclosed embodiments, when the webpage access is tampered with, different defensive means are used for different tampering ways.

If a webpage access request initiated by the client corresponds to N number of callbacks, when the URL carried in the callback is on the white list, the client instructs the

WebBrowser control to normally access and display the webpage corresponding to the URL; when the URL carried in the callback is not on the white list, the client instructs the WebBrowser control to deny access or deny display of the webpage corresponding to the URL (for example, the WebBrowser control may display a risk prompt box at a corresponding position in this case). The URLs carried in the different callbacks are processed by different access controls. Thus, it ensures the user's normal webpage browsing, while an effective defense is carried out for the possible malicious tampering, enhancing the flexibility of the defense against malicious tampering to some extent.

Thus, a client sends a webpage access request to a WebBrowser control, where the webpage access request may also carry a pointer for displaying the webpage frame. If the client finds that the second URL is the same as one of the M trusted URLs, the client instructs the WebBrowser control to access the webpage corresponding to the second URL.

Further, if the client finds that the second URL is the same as the first URL of the M trusted URLs, the client instructs the WebBrowser control to access the webpage corresponding to the second URL and display the obtained webpage corresponding to the second URL at a position corresponding to the pointer for displaying the webpage frame. It can be noted that the callback that carries the second URL may possibly be the first callback of the N callbacks returned from the WebBrowser control to the client. Of course, the callback that carries the second URL may not be the first callback of the N callbacks returned from the WebBrowser control to the client.

In some embodiments, WebBrowser control may send the first URL or other URLs carried in the webpage access request to Domain Name System (DNS) server, and obtain the Internet Protocol (IP) address corresponding to the first URL or other URLs from DNS server. If the client allows the webpage corresponding to the URL to be accessed, the WebBrowser control can access the corresponding webpage based on the IP address corresponding to the first URL or other URLs.

In some embodiments, each URL recorded on the white list can be verified as the trusted URL by a website or other means. Further, credibility of K number of URLs can be verified through a website (the K URLs are obtained from visited URLs in browsing history or downloaded URLs from network.). The trusted URLs of the K URLs can be added to the white list.

Thus, a client sends a webpage access request which carries a first URL to a

WebBrowser control. The client receives N number of callbacks corresponding to the webpage access request from the WebBrowser control. The client compares a second URL carried in a first callback with recorded M number of trusted URLs, where the first callback may be any one callback among N number of callbacks. After comparing, if the client finds that the second URL is the same as one of the M trusted URLs, the client instructs the WebBrowser control to access the webpage corresponding to the second URL; if the client finds that the second URL is different from any one of the M trusted URLs, the client instructs the WebBrowser control to deny access to or deny display of the webpage corresponding to the second URL. The URLs carried in the different callbacks are processed by different access controls. Therefore, it ensures the user's normal webpage browsing, while an effective defense is carried out for the possible malicious tampering, enhancing the flexibility of the defense against malicious tampering to some extent.

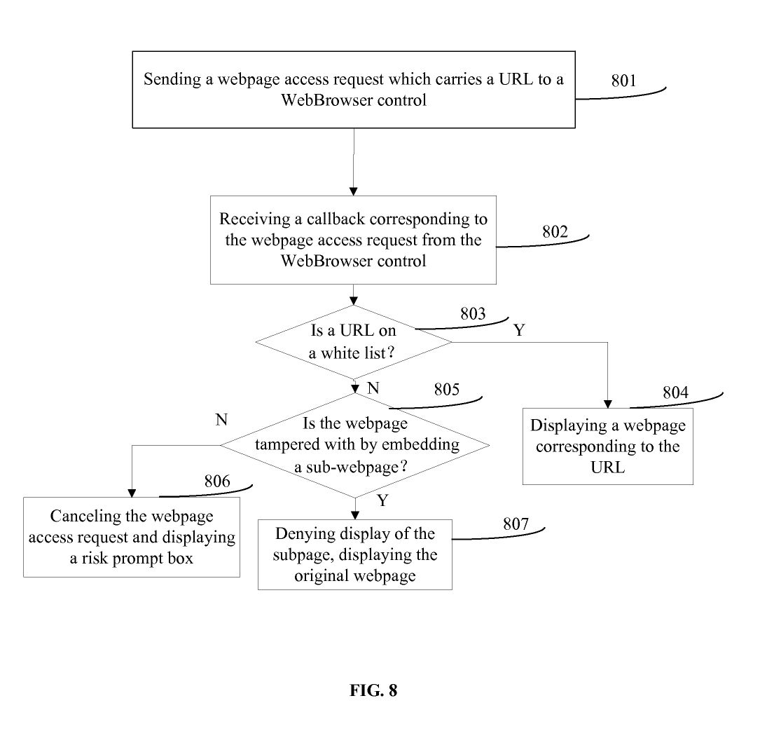

FIG. 8 illustrates a flow chart of another exemplary webpage access control process consistent with the disclosed embodiments. As shown in FIG. 8, the webpage access control process may include the following steps.

Step 801: a client sends a webpage access request which carries a URL to a

WebBrowser control.

Step 802: the client receives a callback corresponding to the webpage access request from the WebBrowser control.

Step 803: the client compares a URL carried in the callback with recorded M number of trusted URLs in a white list.

Step 804: if the client finds that the URL is the same as one of the M number of trusted URLs on the white list, the client displays a webpage corresponding to the URL at a corresponding position.

Step 805: if the client finds that the URL is different from any one of the M number of trusted URLs on the white list, the client determines whether the URL is tampered with or the webpage corresponding to the URL carried in the callback is tampered with by embedding a sub-webpage.

Step 806: if the client determines that the URL is tampered with, the client cancels the webpage access request and displays a risk prompt box.

Step 807: if the client determines that the webpage corresponding to the URL carried in the callback is tampered with by embedding a sub-webpage, the client denies display of the sub-webpage and displays an original webpage.

Thus, the URLs carried in the different callbacks are processed by different access controls. Therefore, it ensures the user's normal webpage browsing, while an effective defense is carried out for the possible malicious tampering, enhancing the flexibility of the defense against malicious tampering to some extent.

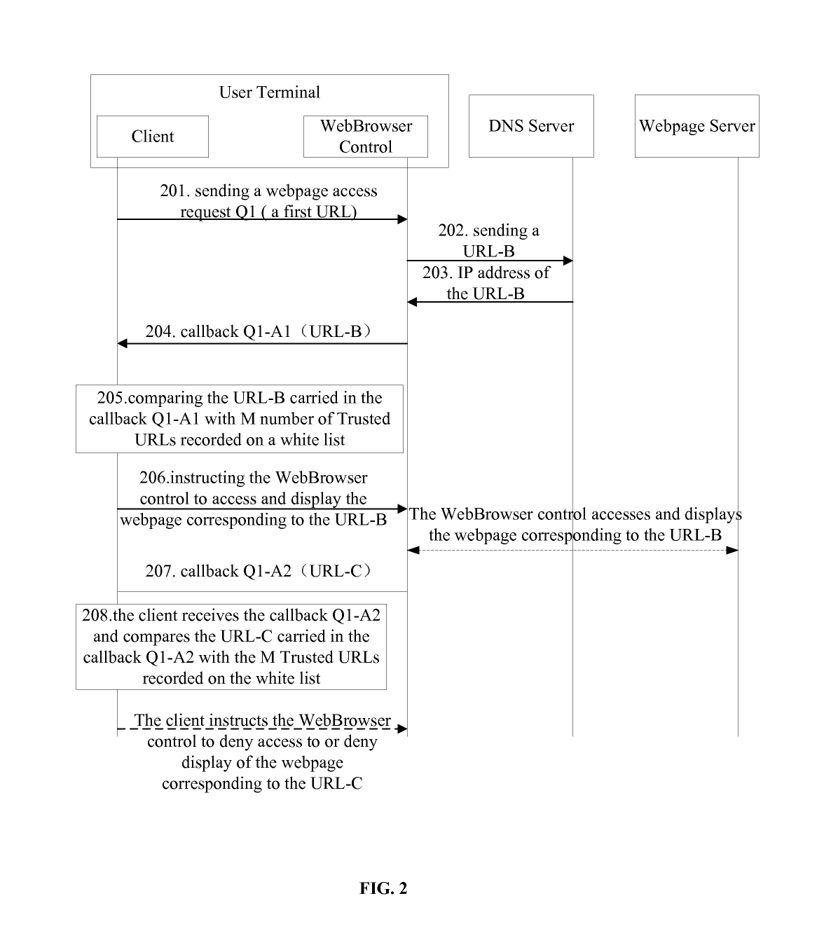

FIG. 2 illustrates a flow chart of another exemplary webpage access control process consistent with the disclosed embodiments. As shown in FIG. 2, the webpage access control process may include the following steps.

Step 201: a client sends a webpage access request Q1 to a WebBrowser control, where the webpage access request Q1 carries a first URL and a pointer for displaying a webpage frame.

The client may refer to any user terminal and/or any software program running on the user terminal, and the client may communicate with a WebBrowser control, e.g., a QQ client, a QQ game client, a QQ microblog client, other instant messaging clients, other social software clients, etc.

When the client sends the webpage access request Q1 which carries the first URL to the WebBrowser control, the first URL carried in the webpage access request Q1 may be tampered with during the process of transferring the webpage access request Q1. For example, a virus program may modify the first URL carried in the webpage access request Q1, making the modified URL point to a phishing website, a pornographic website, a virus release website, etc. As used herein, it is assumed that the first URL carried in the webpage access request Q1 is tampered as a URL-B, and the WebBrowser control may receive the webpage access request Q1 which carries the URL-B.

Step 202: the WebBrowser control sends the URL-B to a Domain Name Server.

Step 203: the WebBrowser control receives an IP address corresponding to the URL-B returned from the Domain Name Server.

Step 204: the WebBrowser control returns a callback Q1-A1 to the client, where the callback Q1-A1 carries the URL-B and a pointer for displaying the webpage frame. The callback Q1-A1 is a callback corresponding to the webpage access request Q1.

Step 205: the client receives the callback Q1-A1 and compares the URL-B carried in the callback Q1-A1 with the M Trusted URLs recorded on a white list.

After comparing, if the client finds that the URL-B does not exist on the white list, the client instructs the WebBrowser control to deny access to and deny display of the webpage corresponding to the URL-B, and the process is ended; if the client finds that the URL-B exists on the white list, the process goes to Step 206. For illustrative purposes, it is assumed that the URL-B exists on the white list.

Step 206: the client instructs the WebBrowser control to access and display the webpage corresponding to the URL-B.

The WebBrowser control accesses the webpage corresponding to the URL-B based on the IP address corresponding to the URL-B returned from Domain Name Server. As used herein, when the WebBrowser control accesses the webpage corresponding to the URL-B, the WebBrowser control finds that the webpage corresponding to the URL-B also references to the webpage corresponding to a URL-C.

Step 207: the WebBrowser control returns a callback Q1-A2 to the client, where the callback Q1-A2 carries the URL-C and a corresponding pointer for displaying the webpage frame, where the callback Q1-A2 is also a callback corresponding to the webpage access request Q1.

Step 208: the client receives the callback Q1-A2 and compares the URL-C carried in the callback Q1-A2 with the M Trusted URLs recorded on the white list.

After comparing, if the client finds that the URL-C exists on the white list, the client instructs the WebBrowser control to normally access and display the webpage corresponding to the URL-C; if the client finds that the URL-C does not exist on the white list, the client instructs the WebBrowser control to deny access to or deny display of the webpage corresponding to the URL-C.

In one embodiment, it is assumed that the URL-C does not exist on the white list. Therefore, the WebBrowser control displays the webpage corresponding to the URL-B; but the WebBrowser control does not display the webpage corresponding to the URL-C. Instead, the WebBrowser control may display a risk prompt box at a corresponding position.

Thus, a client sends a webpage access request Q1 to a WebBrowser control, where the webpage access request Q1 carries a first URL and a pointer for displaying a webpage frame. The WebBrowser control sends a URL-B to a Domain Name Server. The WebBrowser control receives an IP address corresponding to the URL-B returned from the Domain Name Server. The WebBrowser control returns a callback Q1-A1 to the client, where the callback Q1-A1 carries the URL-B and a pointer for displaying the webpage frame, where the callback Q1-A1 is a callback corresponding to the webpage access request Q1. The client receives the callback Q1-A1 and compares the URL-B carried in the callback Q1-A1 with the M Trusted URLs recorded on a white list.

After comparing, if the URL-B does not exist on the white list, the client instructs the WebBrowser control to deny access to and deny display of the webpage corresponding to the URL-B and the process is ended; if the URL-B exists on the white list, the client instructs the WebBrowser control to access and display the webpage corresponding to the URL-B.

The WebBrowser control returns a callback Q1-A2 to the client, where the callback Q1-A2 carries a URL-C and a corresponding pointer for displaying the webpage frame, where the callback Q1-A2 is also a callback corresponding to the webpage access request Q1. The client receives the callback Q1-A2 and compares the URL-C carried in the callback Q1-A2 with the M number of Trusted URLs recorded on the white list. Therefore, it ensures the user's normal webpage browsing, while an effective defense is carried out for the possible malicious tampering, enhancing the flexibility of the defense against malicious tampering to some extent.

FIG. 3 illustrates a flow chart of another exemplary webpage access control process consistent with the disclosed embodiments. As shown in FIG. 3, the webpage access control process may include the following steps.

Step 301: a client sends a webpage access request Q1 to a WebBrowser control, where the webpage access request Q1 carries a first URL and a pointer for displaying a webpage frame.

The client may refer to any user terminal and/or any software program running on the user terminal, and the client may communicate with a WebBrowser control, e.g., a QQ client, a QQ game client, a QQ microblog client, other instant messaging clients, other social software clients, etc.

When the client sends the webpage access request Q1 which carries the first URL to the WebBrowser control, the first URL carried in the webpage access request Q1 may be tampered with during the process of transferring the webpage access request Q1. For example, a virus program may modify the first URL carried in the webpage access request Q1, making the modified URL point to a phishing website, a pornographic website, a virus release website, etc. Here, it is assumed that the first URL carried in the webpage access request Q1 is not tampered with, and the WebBrowser control may receive the webpage access request Q1 which carries the first URL.

Step 302: the WebBrowser control sends the first URL to a Domain Name Server.

Step 303: the WebBrowser control receives an IP address corresponding to the first URL returned from the DNS Server.

Step 304: the WebBrowser control returns a callback Q1-A1 to the client, where the callback Q1-A1 carries the URL-B and a pointer for displaying the webpage frame.

The callback Q1-A1 is a callback corresponding to the webpage access request Q1. Each callback corresponding to the webpage access request returned from the WebBrowser control may carry a URL. The URL-B carried in the callback Q1-A1 may be the same as the first URL, or may be different from the first URL. That is, the URL-B carried in the callback Q1-A1 is the same as the first URL is only one special scenario among many scenarios.

Step 305: the client receives the callback Q1-A1 and compares the URL-B carried in the callback Q1-A1 with the M Trusted URLs recorded on a white list.

After comparing, if the client finds that the URL-B does not exist on the white list, the client instructs the WebBrowser control to deny access to and deny display of the webpage corresponding to the URL-B and the process is ended; if the client finds that the URL-B exists on the white list, the process goes to Step 306. Here, it is assumed that the URL-B exists on the white list.

Step 306: the client instructs the WebBrowser control to access and display the webpage corresponding to the URL-B.

The WebBrowser control accesses the webpage corresponding to the URL-B based on the IP address corresponding to the URL-B returned from the Domain Name Server. As used herein, when the WebBrowser control accesses the webpage corresponding to the URL-B, the WebBrowser control finds that the webpage corresponding to the URL-B also references to the webpage corresponding to a URL-C.

Step 307: the WebBrowser control returns a callback Q1-A2 to the client, where the callback Q1-A2 carries the URL-C and a corresponding pointer for displaying the webpage frame, where the callback Q1-A2 is also a callback corresponding to the webpage access request Q1.

Step 308: the client receives the callback Q1-A2 and compares the URL-C carried in the callback Q1-A2 with the M Trusted URLs recorded on the white list.

After comparing, if the client finds that the URL-C exists on the white list, the client instructs the WebBrowser control to normally access and display the webpage corresponding to the URL-C; if the client finds that the URL-C does not exist on the white list, the client instructs the WebBrowser control to deny access to or deny display of the webpage corresponding to the URL-C.

Here, it is assumed that the URL-C does not exist on the white list. Therefore, the WebBrowser control displays the webpage corresponding to the URL-B. The WebBrowser control does not display the webpage corresponding to the URL-C, and the WebBrowser control may display a risk prompt box at a corresponding position.

Thus, a client sends a webpage access request which carries a first URL to a WebBrowser control. The WebBrowser control sends the first URL to a Domain Name Server. The WebBrowser control receives an IP address corresponding to the first URL returned from the Domain Name Server. The WebBrowser control returns a callback Q1-A1 to the client, where the callback Q1-A1 carries the URL-B and a pointer for displaying the webpage frame, where the callback Q1-A1 is a callback corresponding to the webpage access request Q1. The client receives the callback Q1-A1 and compares the URL-B carried in the callback Q1-A1 with the M number of Trusted URLs recorded on a white list. After comparing, if the URL-B does not exist on the white list, the client instructs the WebBrowser control to deny access to and deny display of the webpage corresponding to the URL-B and the process is ended; if the URL-B exists on the white list, the process goes to Step 306. The client instructs the WebBrowser control to access and display the webpage corresponding to the URL-B. The WebBrowser control returns a callback Q1-A2 to the client, where the callback Q1-A2 carries a URL-C and a corresponding pointer for displaying the webpage frame, where the callback Q1-A2 is also a callback corresponding to the webpage access request Q1. The client receives the callback Q1-A2 and compares the URL-C carried in the callback Q1-A2 with the M Trusted URLs recorded on the white list. Therefore, it ensures the user's normal webpage browsing, while an effective defense is carried out for the possible malicious tampering, enhancing the flexibility of the defense against malicious tampering to some extent.

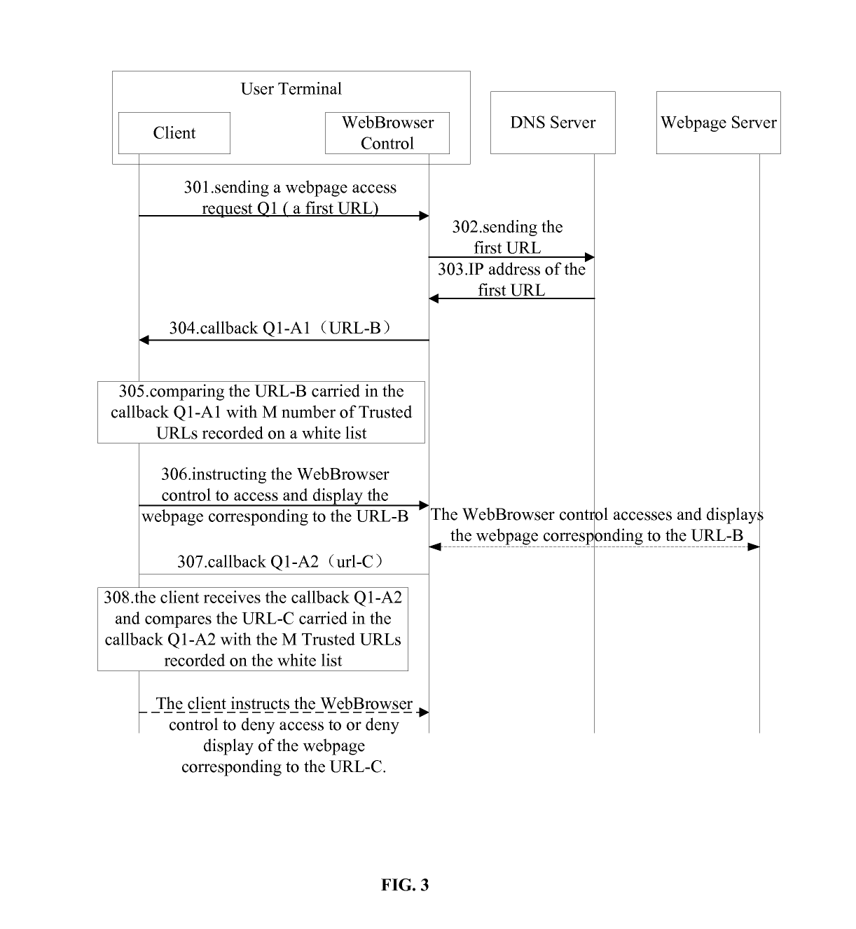

FIG. 4 illustrates a structure diagram of an exemplary webpage access control apparatus consistent with the disclosed embodiments. As shown in FIG. 4, the webpage access control apparatus may include a sending unit 410, a receiving unit 420, a comparing unit 430 and a control unit 440.

The sending unit 410 is configured to send a webpage access request which carries a first URL to a WebBrowser control. The receiving unit 420 is configured to receive N number of callbacks corresponding to the webpage access request from the WebBrowser control.

The comparing unit 430 is configured to compare the second URL carried in the first callback with recorded M trusted URLs, where the first callback may be any one callback among N number of callbacks.

The control unit 440 is configured to instruct the WebBrowser control to access a webpage corresponding to the second URL when the second URL is the same as one of the M trusted URLs, to determine whether the webpage is an embedded sub-webpage when the second URL is different from any one of the M trusted URLs, to instruct the WebBrowser control to deny access to or deny display of the webpage corresponding to the second URL when it is determined that the webpage is not an embedded sub-webpage, and to instruct the WebBrowser control to deny display of the sub-webpage but to allow display an original webpage when it is determined that the webpage is an embedded sub-webpage.

The comparing unit 430 is configured to compare the second URL carried in the first callback with the M trusted URLs recorded on the white list, where the first callback may be any one callback among N number of callbacks. Further, N is a positive integer. For example, N may be 1, 2, or any integer greater than 1.

Further, the sending unit 410 is also configured to send a pointer for displaying the webpage frame carried in the webpage access request.

The control unit 440 is also configured to instruct the WebBrowser control to access a webpage corresponding to the second URL and to display the webpage corresponding to the obtained second URL at a position corresponding to the pointer for displaying the webpage frame carried in the webpage access request if the comparing unit 430 finds that the second URL is the same as the first URL of the M trusted URLs, and to instruct the WebBrowser control to deny access to or deny display of the webpage corresponding to the second URL if the comparing unit 430 finds that the second URL is different from any one of the M trusted URLs, where the first callback may be any one callback among N number of callbacks.

Further, the webpage access control apparatus includes a verification unit and a white list maintenance unit. The verification unit is configured to verify credibility of K number of URLs through a website. The white list maintenance unit is configured to add trusted URLs of the K number of URLs to a white list.

It should be understood that the functions of various function modules in the webpage access control apparatus 400 may be implemented based on the above-described method. The implementing process is not described in details.

Thus, a client sends a webpage access request which carries a first URL to a WebBrowser control. The client receives N number of callbacks corresponding to the webpage access request from the WebBrowser control. The client compares the second URL carried in the first callback with recorded M number of trusted URLs, where the first callback may be any one callback among N number of callbacks.

After comparing, if the client finds that the second URL is the same as one of the M number of trusted URLs, the client instructs the WebBrowser control to access the webpage corresponding to the second URL; if the client finds that the second URL is different from any one of the M trusted URLs, the client instructs the WebBrowser control to deny access to or deny display of the webpage corresponding to the second URL. The URLs carried in the different callbacks are processed by the different access controls. Therefore, it ensures the user's normal webpage browsing, while an effective defense is carried out for the possible malicious tampering, enhancing the flexibility of the defense against malicious tampering to some extent.

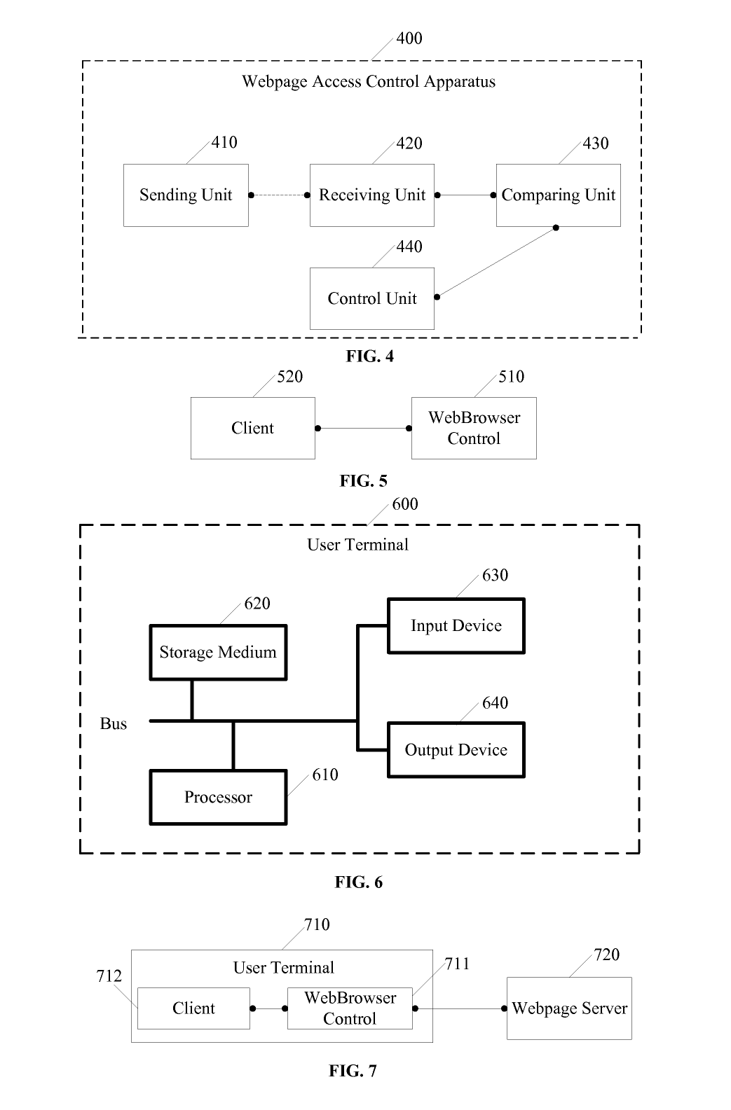

FIG. 5 illustrates a structure diagram of an exemplary webpage access control system consistent with the disclosed embodiments. As shown in FIG. 5, the webpage access control system may include a WebBrowser control 510 and a client 520.

The WebBrowser control 510 is configured to receive a webpage access request which carries a first URL from the client 520 and to return N callbacks corresponding to the webpage access request to the client 520.

The client 520 is configured to send the webpage access request which carries the first URL to the WebBrowser control 510. The client 520 is also configured to receive N number of callbacks corresponding to the webpage access request from the WebBrowser control 510. Further, the client 520 is configured to compare the second URL carried in the first callback with recorded M trusted URLs. After comparing, the client 520 instructs the WebBrowser control 510 to access the webpage corresponding to the second URL if the client 520 finds that the second URL is the same as one of the M trusted URLs, the client 520 instructs the WebBrowser control 510 to deny access to or deny display of the webpage corresponding to the second URL if the client 520 finds that the second URL is different from any one of the M trusted URLs, where the first callback may be any one callback among N number of callbacks.

In some embodiments, a white list can be used to record the M trusted URLs. White list may also be seen written as whitelist or white-list. The white list refers to a list of websites that includes all real websites' domain name address being provided a particular privilege, service, mobility, access or recognition. Only those websites on the white list are accepted, approved or recognized. Of course, the M trusted URLs recorded on the white list may include the first URL, where M is a positive integer. Further, the client compares the second URL carried in the first callback with the M trusted URLs recorded on the white list.

In addition, the webpage access request sent by the client 520 also carries a pointer for displaying the webpage frame. After comparing, if the client 520 finds that the second URL is the same as one of the M trusted URLs, the client 520 instructs the WebBrowser control 510 to access the webpage corresponding to the second URL. If the client 520 finds that the second URL is the same as the first URL of the M trusted URLs, the client 520 instructs the WebBrowser control 510 to access the webpage corresponding to the second URL and displays the webpage corresponding to the obtained second URL at a position corresponding to the pointer for displaying the webpage frame. It can be noted that the callback that carries the first

URL may possibly be the first callback of the N callbacks returned from the WebBrowser control to the client.

In some embodiments, the WebBrowser control 510 may send the first URL or other URLs carried in the webpage access request to DNS server, and obtain the Internet Protocol (IP) address corresponding to the first URL or other URLs from DNS server. If the client 520 allows the webpage corresponding to the URL to be accessed, the WebBrowser control 510 can access the webpage corresponding to the IP address corresponding to the first URL or other URLs based on first URL or other URLs. The WebBrowser control 510 may be embedded in the client 520 or separated from the client 520.

In some embodiments, each URL recorded on the white list can be verified as the trusted URL by a website or other means. Further, the WebBrowser control 510 or the client 520 can verify credibility of K number of URLs through a website (the K URLs are obtained from visited URLs in browsing history or downloaded URLs from network). The trusted URLs of the K URLs can be added to the white list.

It should be understood that the functions of the WebBrowser control 510 and the client 520 may be implemented based on the above-described method. The implementing process is not described in details.

Thus, the client 520 sends the webpage access request which carries a first URL to the WebBrowser control 510. The client 520 receives N number of callbacks corresponding to the webpage access request from the WebBrowser control 510. Further, the client 520 compares the second URL carried in the first callback with recorded M number of trusted URLs. After comparing, the client 520 instructs the WebBrowser control 510 to access the webpage corresponding to the second URL if the client 520 finds that the second URL is the same as one of the M trusted URLs, and instructs the WebBrowser control 510 to deny access to or deny display of the webpage corresponding to the second URL if the client 520 finds that the second URL is different from any one of the M trusted URLs. Therefore, it ensures the user's normal webpage browsing, while an effective defense is carried out for the possible malicious tampering, enhancing the flexibility of the defense against malicious tampering to some extent.

FIG. 6 illustrates a block diagram of an exemplary user terminal consistent with the disclosed embodiments. As shown in FIG. 6, the user terminal 600 may include a processor 610, storage medium 620, an input device 630, and an output device 640. Certain devices may be omitted and other devices may be included.

The processor 610 may include any appropriate processor or processors. Further, the processor 610 can include multiple cores for multi-thread or parallel processing. For illustration purposes, only one processor is shown in FIG. 6. The processor 610, the storage medium 620, the input device 630, and the output device 640 can be connected through buses or other connection methods. The bus connection method is shown in FIG. 6.

The storage medium 620 may include memory modules, such as ROM, RAM, flash memory modules, and erasable and rewritable memory, and mass storages, such as CD-ROM, U-disk, and hard disk, etc. The storage medium 620 may store computer programs for implementing various processes, when executed by the processor 610. Further, the input device 630 may include keyboard, mouse, etc. The output device 640 may include computer screen, mobile phone screen, etc.

The processor 610 sends a webpage access request which carries a first URL to a WebBrowser control. The processor 610 receives N number of callbacks corresponding to the webpage access request from the WebBrowser control. The processor 610 compares the second URL carried in the first callback with recorded M trusted URLs, where the first callback may be any one callback among N number of callbacks. After comparing, if the processor 610 finds that the second URL is the same as one of the M trusted URLs, the processor 610 instructs the WebBrowser control to access the webpage corresponding to the second URL; if the processor 610 finds that the second URL is different from any one of the M trusted URLs, the processor 610 instructs the WebBrowser control to deny access to or deny display of the webpage corresponding to the second URL. N is a positive integer. For example, N may be 1, 2, or any integer greater than 1.

Each callback corresponding to the webpage access request returned from the

WebBrowser control may carry a URL. The URL carried in any callback may be the same as the first URL, or may be different from the first URL. The first callback may be any one callback among N number of callbacks.

In certain embodiments, a white list can be used to record the M trusted URLs. White list may also be seen written as whitelist or white-list. The white list refers to a list of websites that includes all real websites' domain name address being provided a particular privilege, service, mobility, access or recognition. Only those websites on the white list are accepted, approved or recognized. Of course, the M trusted URLs recorded on the white list may include the first URL, where M is a positive integer. Further, the processor 610 compares the second URL carried in the first callback with the M trusted URLs recorded on the white list.

As used herein, the processor 610 sends a webpage access request to a WebBrowser control, where the webpage access request may also carry a pointer for displaying the webpage frame. If the processor 610 finds that the second URL is the same as one of the M number of trusted URLs, the processor 610 instructs the WebBrowser control to access the webpage corresponding to the second URL.

Further, if the processor 610 finds that the second URL is the same as the first URL of the M trusted URLs, the processor 610 instructs the WebBrowser control to access the webpage corresponding to the second URL and display the webpage corresponding to the second

URL at a position corresponding to the pointer for displaying the webpage frame. It can be noted that the callback that carries the first URL may be the first callback among N number of callbacks returned from the WebBrowser control to the processor 610. Of course, the callback that carries the first URL may not be the first callback among N number of callbacks returned from the WebBrowser control to the processor 610.

In some embodiments, WebBrowser control may send the first URL or other URLs carried in the webpage access request to DNS server, and obtain the Internet Protocol (IP) address corresponding to the first URL or other URLs from DNS server. If the processor 610 allows the webpage corresponding to the URL to be accessed, the WebBrowser control can access the corresponding webpage based on the IP address corresponding to the first URL or other URLs.

In some embodiments, each URL recorded on the white list can be verified as the trusted URL by a website or other means. Further, the processor 610 can verify credibility of K number of URLs through a website (the K URLs are obtained from visited URLs in browsing history or downloaded URLs from network). The trusted URLs of the K URLs can be added to the white list.

Typically, the user terminal 600 may be a variety of terminal devices that can browse webpages, such as mobile phones, computer personal digital assistants (PDA), etc.

Thus, the processor 610 sends a webpage access request which carries a first URL to a WebBrowser control. The processor 610 receives N number of callbacks corresponding to the webpage access request from the WebBrowser control. The processor 610 compares the second URL carried in the first callback with recorded M number of trusted URLs, where the first callback may be any one callback among N number of callbacks.

After comparing, if the processor 610 finds that the second URL is the same as one of the M trusted URLs, the processor 610 instructs the WebBrowser control to access the webpage corresponding to the second URL; if the processor 610 finds that the second URL is different from any one of the M trusted URLs, the processor 610 instructs the WebBrowser control to deny access to or deny display of the webpage corresponding to the second URL. The URLs carried in the different callbacks are processed by the different access controls. Therefore, it ensures the user's normal webpage browsing, while an effective defense is carried out for the possible malicious tampering, enhancing the flexibility of the defense against malicious tampering to some extent.

FIG. 7 illustrates a block diagram of an exemplary communication system consistent with the disclosed embodiments. As shown in FIG. 7, the communication system may include a user terminal 710, a webpage server 720 and a DNS server (not shown in FIG. 7). Although only one user terminal 710, one webpage server 720, and one DNS server are shown in the communication system. Any number of user terminals 710, webpage servers 720, and DNS servers may be included, and other devices may also be included.

The webpage server 720 is configured to provide webpages. The DNS server is configured to manage a database that maps domain names to IP addresses. The DNS server runs special-purpose networking software, features a public IP address, and contains a database of network names and addresses for other Internet hosts.

The user terminal 710 includes a WebBrowser control 711 and a client 712.

The WebBrowser control 711 is configured to receive a webpage access request which carries a first URL from the client 712 and to return N number of callbacks corresponding to the webpage access request to the client 712.

The client 712 is configured to send the webpage access request which carries a first URL to the WebBrowser control 711. The client 712 is also configured to receive N number of callbacks corresponding to the webpage access request from the WebBrowser control 711. Further, the client 712 is configured to compare the second URL carried in the first callback with recorded M number of trusted URLs.

After comparing, the client 712 instructs the WebBrowser control 711 to access the webpage corresponding to the second URL if the client 712 finds that the second URL is the same as one of the M trusted URLs, and instructs the WebBrowser control 711 to deny access to or deny display of the webpage corresponding to the second URL if the client 712 finds that the second URL is different from any one of the M trusted URLs, where the first callback may be any one callback among N callbacks.

In some embodiments, a white list can be used to record the M trusted URLs. White list may also be seen written as whitelist or white-list. The white list refers to a list of websites that includes all real websites' domain name address being provided a particular privilege, service, mobility, access or recognition. Only those websites on the white list are accepted, approved or recognized. Of course, the M trusted URLs recorded on the white list may include the first URL, where M is a positive integer. Further, the client compares the second URL carried in the first callback with the M trusted URLs recorded on the white list.

In addition, the webpage access request sent by the client 712 also carries a pointer for displaying the webpage frame. After comparing, if the client 712 finds that the second URL is the same as one of the M trusted URLs, the client 712 instructs the WebBrowser control 711 to access the webpage corresponding to the second URL.

If the client 712 finds that the second URL is the same as the first URL of the M trusted URLs, the client 712 instructs the WebBrowser control 711 to access the webpage corresponding to the second URL and displays the obtained webpage corresponding to the second URL at a position corresponding to the pointer for displaying the webpage frame. It can be noted that the callback that carries the first URL may be the first callback among N number of callbacks returned from the WebBrowser control to the client. Of course, the callback that carries the first URL may not be the first callback among N number of callbacks returned from the WebBrowser control to the processor 610.

In some embodiments, the WebBrowser control 711 may send the first URL or other URLs carried in the webpage access request to DNS server, and obtain the Internet Protocol (IP) address corresponding to the first URL or other URLs from DNS server. If the client 712 allows the webpage corresponding to the URL to be accessed, the WebBrowser control 711 can access the corresponding webpage based on the IP address corresponding to the first URL or other URLs. The WebBrowser control 711 may be embedded in the client 712 or separated from the client 712.

In some embodiments, each URL recorded on the white list can be verified as the trusted URL by a website or other means. Further, the WebBrowser control 711 or the client 712 can verify credibility of K number of URLs through a website (the K URLs are obtained from visited URLs in browsing history or downloaded URLs from network). The trusted URLs of the K URLs can be added to the white list.

Typically, the user terminal 700 may be a variety of terminal devices that can browse webpages, such as mobile phones, computer personal digital assistants (PDA), etc.

It can be seen that the client 712 sends the webpage access request which carries the first URL to the WebBrowser control 711. The client 712 receives N number of callbacks corresponding to the webpage access request from the WebBrowser control 711. Further, the client 712 compares the second URL carried in the first callback with recorded M number of trusted URLs.

After comparing, the client 712 instructs the WebBrowser control 711 to access the webpage corresponding to the second URL if the client 712 finds that the second URL is the same as one of the M trusted URLs, and instructs the WebBrowser control 711 to deny access to or deny display of the webpage corresponding to the second URL if the client 712 finds that the second URL is different from any one of the M trusted URLs. Therefore, it ensures the user's normal webpage browsing, while an effective defense is carried out for the possible malicious tampering, enhancing the flexibility of the defense against malicious tampering to some extent.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

It should be noted that in order to be described simply, the aforementioned embodiments are expressed as combination of a series of actions. However, to those skilled in the art, the present disclosure is not limited to the described sequence of actions, as some blocks may be executed in other sequence or performed simultaneously. Further, those skilled in the art should understand that the embodiments described in the disclosure are preferred embodiments and the actions and modules involved may not be necessary.

In the above-mentioned embodiments, the description of each embodiment has different emphasis, some parts, which are not described in detail in one embodiment, may refer to corresponding descriptions in other embodiments.

As can be seen from the above technical solutions, a client sends a webpage access request which carries a first URL to a WebBrowser control. The client receives N callbacks corresponding to the webpage access request from the WebBrowser control. The client compares the second URL carried in the first callback with recorded M number of trusted URLs, where the first callback may be any one callback among N number of callbacks.

After comparing, if the client finds that the second URL is the same as one of the M trusted URLs, the client instructs the WebBrowser control to access the webpage corresponding to the second URL; if the client finds that the second URL is different from any one of the M trusted URLs, the client instructs the WebBrowser control to deny access to or deny display of the webpage corresponding to the second URL. The URLs carried in the different callbacks are processed by the different access controls. Therefore, it ensures the user's normal webpage browsing, while an effective defense is carried out for the possible malicious tampering, enhancing the flexibility of the defense against malicious tampering to some extent.

To those skilled in the art, it is understood that the system, device and method disclosed above may be implemented by alternative means based on the concepts of the embodiments described above. The devices used in the above embodiments are for illustration only. For example, the units are divided by way of functions and logic, but the units can be divided by other ways such as combining or integrating a plurality of units or components, or some features may be ignored or not executed. Moreover, the coupling, direct coupling or communication connection illustrated in drawings or described in descriptions of the embodiments can be realized through some interfaces; and the indirect coupling or communication connection between devices and units can be realized by electrical or mechanical means.

The individual units may be or may not be separated physically to each other. Each component in the form of illustrated unit may be or may not be a physical unit. The units described in the embodiments can be located in the same place or distributed to a plurality of network units. The object of the present embodiments can be realized by the whole or a portion of the units based on actual requirement.

In addition, the functional units in the embodiments of the present disclosure can be integrated into a processing unit, and exist physically and individually, or partially integrated into one unit. The integrated unit described above can be realized in the form of hardware or in the form of a software function unit.

The integrated unit, if being realized by form of software functional unit and being able to be sold or used independently, may be stored in a computer readable storage medium. Based on such understanding, the essence of the technical solution of the present disclosure, the contributing part to the prior art, the whole or part of the technical solution can be realized in form of a software product. The computer software product is stored in a storage medium and includes a plurality of instructions for configuring a computer equipment (e.g., a personal computer, server, or network equipment, etc.) to perform all or part of the steps in the method described in different embodiments of the present disclosure. The storage medium includes: an USB disk, removable hard disk, read-only memory (ROM), random access memory (RAM), hard disk or CD-ROM or any various mediums that can store program code.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed method, apparatus and system for webpage access control, a client sends a webpage access request which carries a first URL to a WebBrowser control. The client receives N number of callbacks corresponding to the webpage access request from the WebBrowser control. The client compares the second URL carried in the first callback with recorded M number of trusted URLs, where the first callback is any one callback among N number of callbacks. After comparing, if the client finds that the second URL is the same as one of the M trusted URLs, the client instructs the WebBrowser control to access the webpage corresponding to the second URL; if the client finds that the second URL is different from any one of the M trusted URLs, the client instructs the WebBrowser control to deny access to or deny display of the webpage corresponding to the second URL. The URLs carried in the different callbacks are processed by the different access controls. Therefore, it ensures the user's normal webpage browsing, while an effective defense is carried out for the possible malicious tampering, enhancing the flexibility of the defense against malicious tampering to some extent.

What is claimed is:

1. A method for webpage access control, comprising:
sending, by a client, a webpage access request which carries a first uniform/universal resource locator (URL) to a browser control;
receiving, by the client, N number of callbacks corresponding to the webpage access request from the browser control, wherein N is an integer greater than 1;
comparing, by the client, a second URL carried in a first callback with recorded M number of trusted URLs, wherein M is a positive integer and the first callback is any one callback among the N callbacks;
when the second URL is the same as one of the M trusted URLs, instructing, by the client, the browser control to access a webpage corresponding to the second URL;
when the second URL is different from any one of the M trusted URLs, determining, by the client, whether the webpage is an embedded sub-webpage;
when it is determined that the webpage is not an embedded sub-webpage, instructing the browser control to cancel the webpage access request; and
when it is determined that the webpage is an embedded sub-webpage; instructing the browser control to deny display of the sub-webpage but to allow display an original webpage.

2. The method according to claim 1, wherein comparing a second URL carried in a first callback with recorded M number of trusted URLs further includes:
comparing the second URL carried in the first callback with the M trusted URLs recorded on a white list.

3. The method according to claim 2, further including:
verifying credibility of K number of URLs through a website, wherein K is a positive integer; and
adding the trusted URLs of the K URLs to the white list.

4. The method according to claim 3, wherein:
the K URLs are obtained from visited URLs in browsing history; and
the K URLs are obtained from downloaded URLs from network.

5. The method according to claim 3, wherein:
the webpage access request carries a pointer for displaying a webpage frame;
when the second URL is the same as one of the M trusted URLs, instructing the browser control to access the webpage corresponding to the second URL; and
when the second URL is the same as the first URL of the M trusted URLs, instructing the browser control to access the webpage corresponding to the second URL and to display the obtained webpage corresponding to the second URL at a position corresponding to the pointer for displaying the webpage frame.

6. The method according to claim 1, before receiving N number of callbacks corresponding to the webpage access request from the browser control, further including:
sending, by the browser control, the URL carried in the web access request to a domain name system (DNS) server;
receiving, by the browser control, Internet Protocol (IP) addresses corresponding to the URLs of webpages to be jumped to from the DNS server; and
returning, by the browser control, the N callbacks to the client, wherein each callback carries relevant data of a webpage to be jumped to.

7. The method according to claim 1, wherein:
the browser control is embedded in the client.

8. An apparatus for webpage access control, comprising:
a sending unit configured to send a webpage access request which carries a first URL to a browser control;
a receiving unit configured to receive N number of callbacks corresponding to the webpage access request from the browser control, wherein N is an integer greater than 1;
a comparing unit configured to compare a second URL carried in a first callback with recorded M number of trusted URLs, wherein M is a positive integer and the first callback is any one callback among N number of callbacks; and
a control unit configured to:
instruct the browser control to access a webpage corresponding to the second URL when the second URL is the same as one of the M trusted URLs;
determine whether the webpage is an embedded sub-webpage when the second URL is different from any one of the M trusted URLs;
instruct the browser control to deny access to or deny display of the webpage corresponding to the second URL when it is determined that the webpage is not an embedded sub-webpage; and
instruct the browser control to deny display of the sub-webpage but to allow display an original webpage when it is determined that the webpage is an embedded sub-webpage.

9. The apparatus according to claim 8, wherein the comparing unit is further configured to:
compare the second URL carried in the first callback with the M trusted URLs recorded on the white list, wherein the first callback is any one callback among N number of callbacks.

10. The apparatus according to claim 9, wherein the apparatus for webpage access control further includes:
a verification unit configured to verify credibility of K number of URLs through a website, wherein K is a positive integer; and
a white list maintenance unit configured to add trusted URLs of the K URLs to a white list.

11. The apparatus according to claim 10, wherein:
the K URLs are obtained from visited URLs in browsing history; and
the K URLs are obtained from downloaded URLs from network.

12. The apparatus according to claim 8, wherein:
the sending unit configured to send a pointer for displaying the webpage frame carried in the webpage access request.
the control unit configured to:
instruct the browser control to access the webpage corresponding to the second URL; display the obtained webpage corresponding to the obtained second URL at a position corresponding to the pointer for displaying the webpage frame carried in the webpage access request when the second URL is the same as the first URL of the M trusted URLs;
determine whether the webpage is an embedded sub-webpage when the second URL is different from any one of the M trusted URLs;
instruct the browser control to deny access to or deny display of the webpage corresponding to the second URL when it is determined that the webpage is not an embedded sub-webpage; and
instruct the browser control to deny display of the sub-webpage but to allow display an original webpage when it is determined that the webpage is an embedded sub-webpage.

13. A system for webpage access control, comprising:
a webpage server configured to provide webpages;
a DNS server configured to manage a database that maps domain names to IP addresses; and
a user terminal, comprising:
a client;
a browser control configured to receive a webpage access request which carries a first URL from the client and to return N number of callbacks corresponding to the webpage access request to the client, wherein N is an integer greater than 1 and the first callback is any one callback among N number of callbacks; and
wherein the client configured to:
send the webpage access request which carries the first URL to the browser control;
receive N number of callbacks corresponding to the webpage access request from the browser control;
compare a second URL carried in a first callback with recorded M number of trusted URLs, wherein M is a positive integer;
instruct the browser control to access the webpage corresponding to the second URL when the second URL is the same as one of the M trusted URLs;
determine whether the webpage is an embedded sub-webpage when the second URL is different from any one of the M trusted URLs;
instruct the browser control to deny access to or deny display of the webpage corresponding to the second URL when it is determined that the webpage is not an embedded sub-webpage; and
instruct the browser control to deny display of the sub-webpage but to allow display an original webpage when it is determined that the webpage is an embedded sub-webpage.

14. The system according to claim 13, wherein the browser control is further configured to:
send the URL carried in the web access request to a DNS server;
receive IP addresses corresponding to the URLs of webpages to be jumped to from the DNS server; and
return N number of callbacks to the client, wherein each callback carries relevant data of a webpage to be jumped to.

15. The system according to claim 13, wherein:
the browser control is embedded in the client.
